(19) United States
(12) Patent Application Publication
(10) Pub. No.: US 2003/0139986 A1
(43) Pub. Date: Jul. 24, 2003

(54) Spend analysis system and method

(75) Inventor: Roland Louis Roberts JR., Dallas, TX (US)

Correspondence Address: Baker Botts L.L.P., Suite 600, 2001 Ross Avenue, Dallas, TX, 75201-2980, US

(73) Assignee: Electronic Data Systems

(21) Appl. No.: 10/056,105

(22) Filed: Jan. 23, 2002

(51) Int. Cl. G06F 17/60

(52) U.S. Cl. 705/30

(57) ABSTRACT

A method for tracking spend includes receiving a plurality of accounts payable items, each accounts payable item being associated with one of a plurality of general ledger codes. More than one of the plurality of general ledger codes are associated with an associated one of a plurality of purchasing categories. At least one of the plurality of general ledger codes which does not include an associated one of the plurality of purchasing categories is identified. Unallocated spend items associated with the at least one of the general ledger codes are displayed to a user. In accordance with one embodiment, information regarding a proper correlation of the spend items within the plurality of purchasing categories is received from the user.

### BACKGROUND OF THE INVENTION

Large businesses and organizations often participate in many different business types across various geographic regions. In many instances, one or more business units of an organization are handled independently of one another with regard to accounting and reporting within the organization. This is particularly true where an organization includes several departments, branches, subsidiaries, affiliates, etc. Each business unit may have a different configuration of hardware, software or reporting techniques for tracking spend within the organization.

In order to analyze accounting statistics related to the organization, information is collected form each business unit. It is often difficult to determine overall, cumulative accounting statistics, since each business unit employs different accounting and reporting techniques. Accordingly, a substantial amount of time and resources are required to analyze such figures and predict and/or report overall statistics for the entire organization.

### SUMMARY OF THE INVENTION

In accordance with the present invention, the disadvantages and problems associated with previous spend analysis techniques have been substantially reduced or eliminated. In particular, the present invention provides a system and method for converting accounts payable items into true spend items associated with particular purchasing categories. Accordingly, a user may determine true spend according to one or more categories including true spend for a given supplier, type of good and/or business unit. Such information can be compared with baseline data representing previous true spend by category, which allows a user to identify significant trends or changes in spend by category.

In accordance with one embodiment of the present invention, a method for tracking spend includes receiving a plurality of accounts payable items, each accounts payable item being associated with one of a plurality of general ledger codes. More than one of the plurality of general ledger codes may be associated with one of a plurality of purchasing categories. At least one of the plurality of general ledger codes which does not include an associated one of the plurality of purchasing categories is identified. Unallocated spend items associated with at least one of the general ledger codes is displayed to a user.

In accordance with a particular embodiment, information regarding a proper correlation of the spend items within the plurality of purchasing categories is received from a user. In various embodiments, the purchasing categories may correspond to suppliers, types of goods, and/or business units.

In accordance with another embodiment, one or more general ledger codes, which are likely to include one or more of a plurality of non-discretionary spend items are identified. Each of the plurality of accounts payable items that are associated with the one or more general ledger codes are presented to a user for analysis.

Technical advantages of particular embodiments of the present invention include a system and method for analyzing true spend within an organization. Each accounts payable item is associated with a particular purchasing category. In this manner, general ledger codes associated with miscellaneous type items may be reviewed manually and assigned to a specific purchasing category. Accordingly, the true spend associated with each purchasing category can be established.

Another technical advantage of particular embodiments of the present invention includes a system and method for identifying non-discretionary spend items. Non-discretionary spend items are less significant to a spend analysis and not as useful to a user, since very few options are available to a user for influencing such non-discretionary spend items.

Yet another technical advantage of particular embodiments of the present invention includes a system and method for associating each discretionary spend item with a particular purchasing category. Accordingly, a user can determine the true spend associated with a particular supplier, type of good, or business unit. This analysis may lead a user to identify particular purchasing categories in which significant resources are being expended, in order to consolidate such purchases with a particular supplier, and/or negotiate a discounted unit price per item based upon the overall volume.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and the advantages thereof, reference is now made to the following descriptions, taken in connection with the accompanying drawings, in which:

FIG. 1 illustrates an accounts payable report including a plurality of accounts payable items, in accordance with a particular embodiment of the present invention;

FIG. 2 illustrates a method for analyzing spend, in accordance with a particular embodiment of the present invention;

FIG. 3 illustrates a representative portion of a trending report generated in accordance with the method of FIG. 2, in accordance with a particular embodiment of the present invention;

FIG. 4 illustrates an hierarchy of business units within a company, each of which may be associated with a particular purchasing category, in accordance with a particular embodiment of the present invention; and

FIG. 5 illustrates a communication network for consolidating accounts payable information, in accordance with a particular embodiment of the present invention.

### DETAILED DESCRIPTION OF THE INVENTION

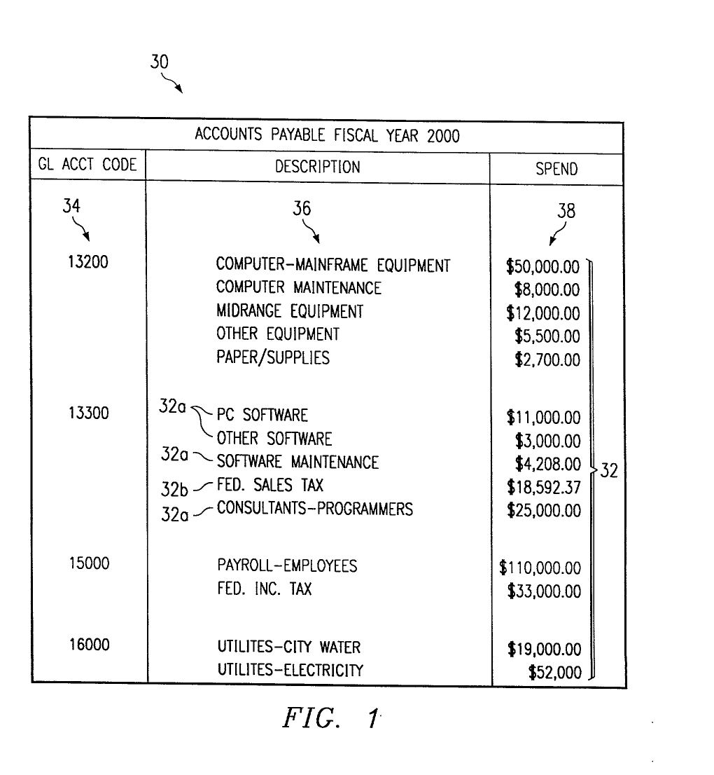

FIG. 1 illustrates an accounts payable report 30, which includes a plurality of accounts payable items 32. Accounts payable report 30 is typical of reporting mechanisms and techniques maintained by many organizations, in order to track money to be spent, and/or already spent. In the illustrated embodiment, each accounts payable item 32 is identified by a specific general ledger account code 34, description 36, and amount spent 38. Accounts payable report 30 covers the fiscal year 2000. However, report 30 is a representative sample, and does not include all accounts payable items for fiscal year 2000, for the organization in question. Depending upon the size of the organization, a particular accounts payable report may include hundreds, or even tens of thousands of accounts payable items. Accounts payable items 32 are used herein to illustrate a sample of overall accounts payable items, in order to demonstrate the teachings of the present invention.

In accordance with a particular embodiment of the present invention, accounts payable report 30, and the associated accounts payable items 32 are used to determine “true spend” by an organization, according to specific categories. Such categories may include spend according to a particular supplier, type of good(s) or service(s), and/or business unit, associated with the accounts payable item(s). In most instances, using an accounts payable report to determine overall spend by an organization is insufficient to determine “true spend” according to one or more of the categories described above, since mistakes are often made when items are input into an accounts payable report. For example, general ledger categories, descriptions, cost center and other identifiers associated with accounts payable items 32 may be identified incorrectly by the party recording such information. Similarly, organizations often use particular general ledger categories to record unrelated, miscellaneous items, where the party inputting the information is unsure about the correct identifiers.

The term “true spend” is used to describe the results derived in accordance with particular embodiments of the present invention, because steps are taken to correct information which was input incorrectly, and/or more specifically allocate accounts payable items associated with general, or miscellaneous spend categories. Accordingly, the results derived in accordance with particular embodiments of the present invention are more accurate with regard to the amount of money actually spent in one or more of the categories described above.

Accounts payable items 32 include discretionary spend items 32a, and non-discretionary spend items 32b. Discretionary spend items 32a and non-discretionary spend items 32b may be referred to herein, collectively as accounts payable items 32. Discretionary spend items 32a include those accounts payable items 32 over which the organization may exercise influence over the supplier, or provider of the goods or services associated with the accounts payable item 32. The ability to exercise influence over the supplier includes the ability to negotiate a discount or preferred pricing based upon the quantity of goods or services purchased, and/or the total amount paid from the organization to the supplier or provider, in consideration for such goods and services. In contrast, non-discretionary spend items are those over which the organization likely may not exercise influence over the supplier or provider, pursuant to the considerations described in the preceding sentences.

In many instances, whether or not an accounts payable item is a discretionary spend item 32a, or a non-discretionary spend item 32b, is often a subjective judgment call to be made by a member of the organization. By way of example, and with reference to general ledger account code 13300 of FIG. 1, PC software, other software, software maintenance, and consultants-programmers may all be considered discretionary spend items 32a, since the organization presumably has a relatively high degree of influence over the amount paid to the supplier or provider, for such accounts payable items 32a. In other words, if the organization recognizes that they are spending a significant amount of money on a particular good or service, a member of the organization may approach the supplier or provider and ask for a discount on the unit price of each good or service, consistent with the quantity being purchased. If the particular provider or supplier refuses, the organization may opt to contact other providers or suppliers of similar or identical goods or services, and seek a lower, discounted price, based upon the anticipated quantity of goods or services to be purchased in the future.

On the other hand, federal sales tax associated with the goods or services of general account codes 13300 may be considered a non-discretionary spend item 32b, since the organization is not likely to influence the federal sales tax charged by the federal government. For similar reasons, taxes and surcharges charged by federal, state and or local authorities, or similar charges, are typically considered non-discretionary spend items, unless it is determined that such charges are subject to negotiation with the particular authority or supplier.

Similarly, with reference to GL Account code 1600, utilities-city water and utilities-electricity may each be considered non-discretionary spend items, since it is unlikely that the organization can negotiate such charges with the supplier. In some embodiments, accounts payable items which are only available from one source which is generally inflexible over the amount charged for particular goods or services may be considered non-discretionary spend items 32b.

In accordance with particular embodiments of the present invention, reports may be generated which include non-discretionary spend items in one or more categories, separate from discretionary spend items 32a, or non-discretionary spend items 32b may be excluded entirely. This is done because it may be desirable to determine the amount of money being spent on discretionary spend items, without regard to non-discretionary spend items 32b. For example, in accordance with a particular embodiment of the present invention, reports may be generated which allow a member of the organization to review the amount of money spent within the categories described above (e.g., supplier, type of good(s) or service(s), and/or business unit, associated with the accounts payable item(s)).

This information allows the member to identify a particular supplier, for example, with which the organization is spending a significant amount of money, in order to approach the supplier to negotiate a discount. Similarly, the report may allow the member to identify a particular good or service on which a significant amount of money is being spent. Accordingly, the member may consider consolidating the purchasing of such goods or services with one or more suppliers/providers, in order to negotiate a discount. This is helpful in many instances, including those in which a large organization is spending significant amounts of money with various suppliers throughout a substantial geographic region (e.g., worldwide), and it is otherwise difficult to determine with which supplier(s) a significant amount of money is spent, and/or on which particular goods or services a significant amount of money is being spent.

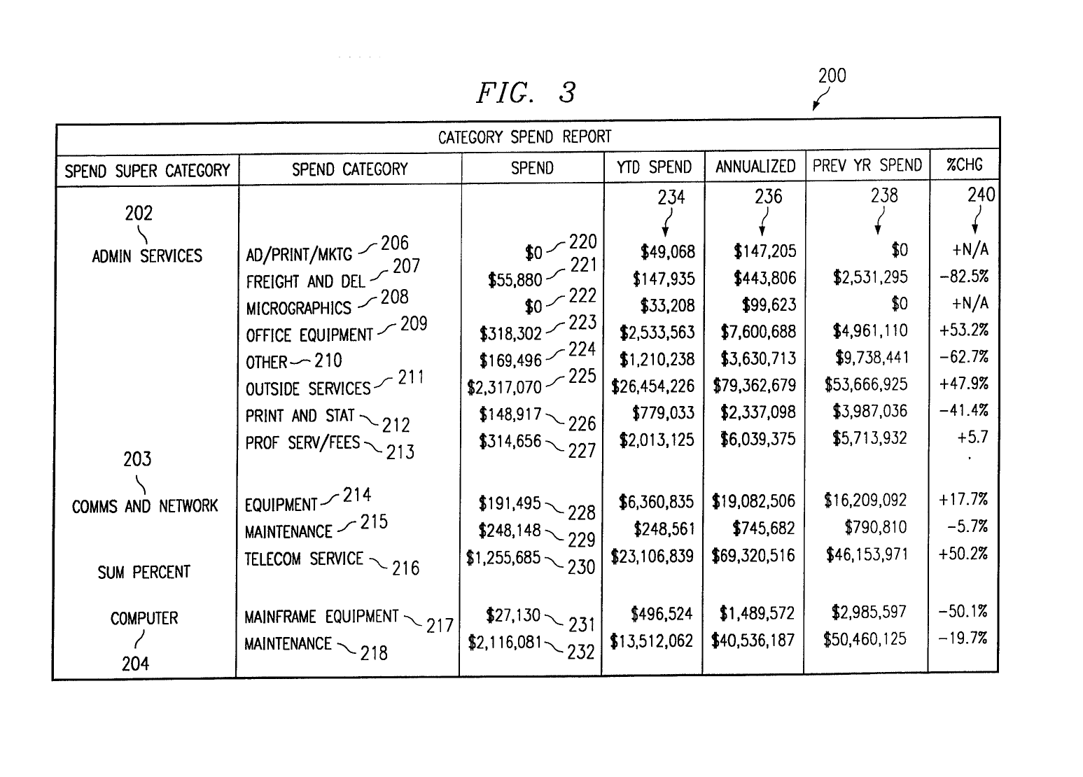

In accordance with still another embodiment of the present invention, the data derived in accordance with one or more of the techniques described above may be compared with baseline data, in order to determine performance over a given period of time, with respect to the baseline data. For example, the baseline data may be the amount of money spent on a given category over a prior fiscal, or calendar year. In this manner, money being spent on similar or identical goods or services, or with particular suppliers, during the current year can be compared with the baseline data in order to determine significant changes. Such changes may lead a member of the organization to identify a problem area within the organization, or a potential budget overrun. Alternatively, such changes may allow a member of the organization to identify a particular supplier with whom volume discounts may be renegotiated, based upon increased spending. Such comparative reports will be discussed later in more detail, with regard to FIG. 3.

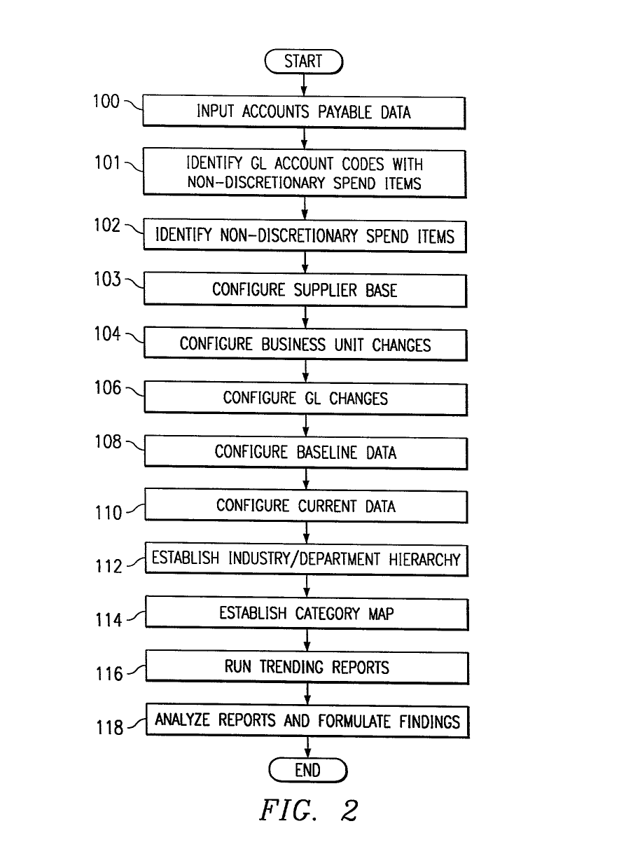

FIG. 2 illustrates a method for analyzing spend, in accordance with a particular embodiment of the present invention. The method begins at step 100, where accounts payable data is received. The accounts payable data may include a variety of accounts payable items 32. It should be recognized that many identifiers may be used in order to identify, and/or categorize a specific accounts payable item 32. FIG. 1 includes three such identifiers, being a general ledger account code 34, a description 36, and an amount of spend 38. However, many other categories and/or subcategories may be associated with a particular accounts payable item 32.

Such accounts payable data may be maintained in electronic form, and stored in an electronic storage medium. In a particular embodiment, the accounts payable data may be imported from a database maintained within an organization. Typically, such databases include all goods or services paid for over a given time period. Also, the way in which the data is stored does not lend itself to simplified manipulation and analysis, in order to present such data in a usable format, as described herein.

In many instances, accounts payable data is maintained within an organization using more than one type of hardware, electronic storage medium, software, and/or other tracking tools, located at different geographic regions. Such systems may or may not be connected via a communications network, for example, a local area network (LAN), metropolitan area network (MAN), wide area network (WAN) and/or the Internet. Therefore, at step 100, the teachings of the present invention provide a system and method with the ability to import, store and/or manipulate data received from a variety of such sources. Similarly, many of the steps of FIG. 2 including, without limitation, steps 102-108 may include the ability to interface with a variety of different hardware, software, and/or storage systems.

Particular general ledger account codes which may include non-discretionary spend items are identified at step 101. Generally, there are a plurality of general ledger account codes which are expected to include non-discretionary spend items. Also, it may be expected that general ledger account codes used for “miscellaneous” items may include non-discretionary spend items.

Next, at step 102, the general ledger account codes that may include non-discretionary spend are reviewed in order to identify the particular non-discretionary spend items, so that they can be categorized as such. This allows the non-discretionary spend items to be separated from discretionary spend items and/or excluded from certain reports altogether.

At step 103, the supplier base is configured. Configuring the supplier base includes determining the suppliers associated with the accounts payable data input, or received (imported) at step 100. Accordingly, each accounts payable item associated with the accounts payable data input at step 100 may be associated with a particular supplier. In a particular embodiment, non-discretionary spend items may be excluded from this step. In this manner, accounts payable data from different systems around the world can be reviewed in order to match-up goods or services with their respective suppliers, to show a cumulative total of all spend associated with the particular supplier. This is possible even when different branches or divisions of the overall organization are spending the money on that particular supplier, without the knowledge of other branches or divisions.

Next, at step 104 business unit charges are configured. Business units include identifiers which represent the organizational structure of business units within the organization. Such “org charts” represent geographical and/or logical structure of the organization, and also represent the management structure, for example, which business units report to which managers, directors and other executives of the organization.

Since the structure and organization of business units, as well as the responsible manager or executive may change periodically, the teachings of the present invention provide a mechanism to record and store the current organization of business units, as well as tracking any changes in the structure or organization of the business unit since the last reporting period. As will be described later in more detail, this allows a more accurate comparison with the performance with respect to baseline data, taking into account such changes in the structure and/or organization of the business units within the organization.

At step 106, general ledger code changes Mare configured. Several changes may be made to the general ledger account codes 34, in accordance with the teachings of the present invention. Initially, the accounts payable data is imported at step 100, and such data includes associated general ledger account codes 34. Often times, general ledger account codes 34 are assigned by purchasing department or accounts payable department personnel, and are not in a form which may be used by financial analysts to determine cumulative values regarding how much money has actually been spent, what goods or services it has been spent on, the suppliers with whom it has been spent, and the particular business unit, manager, and/or executive ultimately responsible for the money being spent.

In order to more effectively analyze the accounts payable data, new general ledger codes may be assigned at step 106. Therefore, general ledger account codes 34 associated with the accounts payable data are correlated with new general ledger codes. In some instances, the new general ledger codes may exactly correspond to the old general ledger codes. In others, the system of the present invention changes the general ledger code(s) associated with the accounts payable data. The changes to the general ledger data allow manipulation, arrangement, and/or use the new general ledger code(s) to calculate more useful information regarding true spend by category. Furthermore, the data may be manipulated, arranged and/or used to calculate data regarding discretionary spend which may be more useful to the operator of the system.

Many of the general ledger account codes 34 may be imported into a database and reused, and/or altered automatically by a processor, according to a predetermined correlation between the “old” general ledger account codes 34 and the new general ledger account codes. In some instances, certain general ledger account codes 34 cannot be easily and/or automatically correlated into a new general ledger account code. Therefore, the system of the present invention may be preconfigured to automatically present accounts payable items associated with such general ledger account codes, so that an operator can review the accounts payable item and assign an appropriate new general ledger code.

Similarly, there may be general ledger codes that are used for “miscellaneous” accounts payable items, or items for which the individual inputting the accounts payable item did not know where to allocate the accounts payable item. Therefore, the system of the present invention may be preconfigured to automatically identify such general ledger account codes, in order to present some or all of the accounts payable items therein to an operator, such that appropriate general ledger account codes may be assigned.

At step 108, baseline data is configured. Baseline data includes data regarding accounts payable items and/or general ledger account codes from a previous period of time, which is used to compare to current data. For example, the system and method of the present invention may be configured to compare information from the current year, with information from previous year(s). The year in question may be a fiscal year, calendar year, or a predefined twelve month period of interest. However, other periods of time may be used within the teachings of the present invention. Information from the past may be used to compare to information associated with account payable items from the current year. In a particular embodiment, current year information may be prorated, for comparison to data from prior years. For example, at the end of the first quarter (four month period) of the current year, the totals may be automatically multiplied by four, and compared with last year's data (from the fourth quarter), in order to determine the percentage change in accounts payable categories (e.g., suppliers, supply categories, and/or business units) from previous year's data.

Next, at step 110, the current year's data is configured. The configuration of the current year's data refers to the collection, manipulation, calculation and/or allocation of the imported accounts payable items into a form which may be analyzed according to a specific category and/or compared with the prior year's data. Therefore, the system and method of the present invention allow the preparation of reports for analysis and comparison of data, as discussed in more detail with regard to FIG. 3.

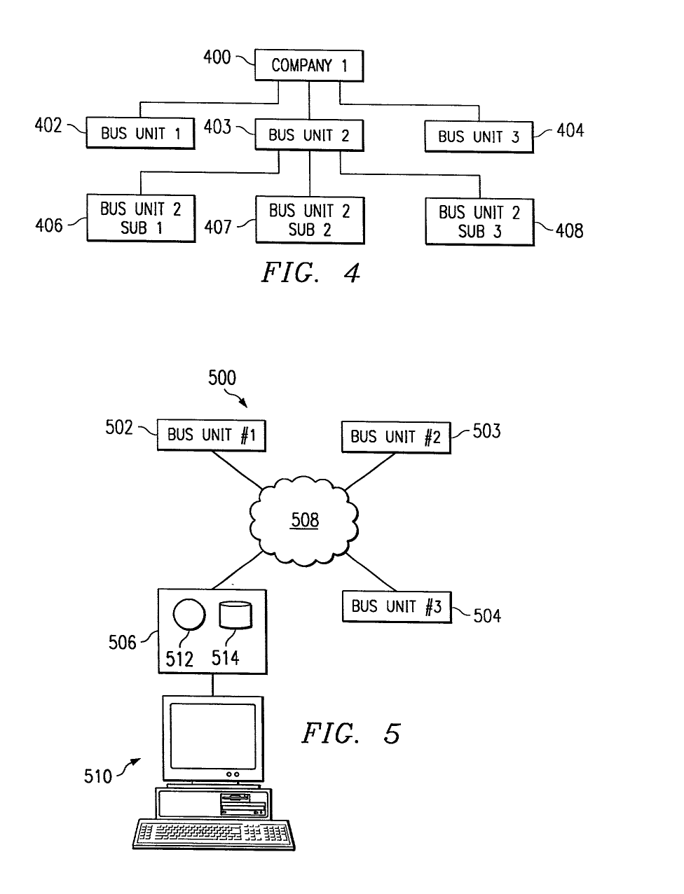

At step 112, an industry/department hierarchy may be established, in order to analyze accounts payable items with respect to associated business units, or other organizational structure within the organization. FIG. 4 illustrates a sample industry/department hierarchy, in accordance with a particular embodiment of the present invention. In many instances, the industry/department hierarchy will be substantially more complex than FIG. 4. For example, any particular company may include dozens, or even hundreds of business units, and hundreds to thousands of subcategories of business units. Fir illustrative purposes. FIG. 4 illustrates three business units and one business unit includes three subcategories of business units, for illustrative purposes.

FIG. 4 illustrates a company 400 which includes three distinct business units 402-404. The breakdown of business units may include business types, corporate structure, manager responsibility or geographic region, within the teachings of the present invention. For example, business units 402-404 may represent a company's operations in Europe, North America and South America, respectively. Alternatively, each business unit 402-404 may represent business operations under the management of a particular executive or manger. Within the teachings of the present invention, true spend associated with each business unit may be determined, by associating all spend items and/or general ledger categories with a particular business unit.

Each business unit 402-404 may have any number of associated subcategories 406-408. In a particular embodiment, subcategories 406-408 may represent lower level managers responsible to the manger of business units 403. Alternatively, subcategories 406-408 may represent smaller geographic regions within the geographic region defined by business unit 403.

Although the specific breakdown of and arrangement of business units within this hierarchy is subject to change, the teachings of the present invention provide a method to account for such changes in preparing tending reports similar to the report of FIG. 3. For example, if business unit 1, subcategory 3 was a subcategory of business unit 3 last year, and is now a subcategory of business unit 2, the trending report will take this into account. Therefore, the baseline data (previous year spend) of FIG. 3, represents spend as if business unit 1, subcategory 3 had been associated with business unit 2 last year. Accordingly, changes in manager's responsibilities and the structure of the organization can be tracked, and baseline data will take such changes into account.

At step 114, a category map is established. The category map is created in order to map standard supply categories with a chart of accounts. This is helpful since many organizations maintain proprietary charts of accounts, with each category of goods, services, or supplies arranged in different ways. For example, a category map may include one or more categories each having one or more levels of associated subcategories. In one embodiment, a category of “Computer Equipment” may have a subcategory entitled “Hardware,” which may have another associated subcategory entitled “Server Hardware.” The category map allows an operator of the system such that all chart of accounts categories correspond to a category regarding type of goods or services, supplier, and/or business unit.

Trending reports are run at step 116. A sample trending report is illustrated in FIG. 3. In accordance with a particular embodiment of the present invention the trending reports are automatically generated and arranged for further analysis by an operator of the system. Such trending reports may be used to analyze and compare the current year's spend data, in order to identify discrepancies, potential problems, economic waste, and/or identify particular suppliers and/or supply categories in which volume discounts may be investigated, at step 118.

FIG. 3 illustrates a representative portion of a trending report 200, prepared in accordance with a particular embodiment of the present invention. Trending report 200 includes a plurality of identifiers associated with accounts payable items which occurred during a specific time period, and were imported at step 100 of FIG. 2. Each accounts payable item is identified by a super spend category 202-204, and a spend category 206-218. Super spend categories 202-204 and/or spend categories 206-218 may be referred to as a plurality of general ledger account codes. The super spend categories and spend categories may be derived, at least in part, from the general ledger account codes of FIG. 1. However, as described above, many of the accounts payable items of FIG. 1 may be reviewed manually by an operator, in order to assign the appropriate general ledger code, super spend category, and/or spend category of the present invention.

The spend 220-232 associated with each accounts payable item corresponds to the amount of money spent on the goods or services associated with the category item(s). Each item of spend 220-232 has an associate year to date spend value from year to date spend column 234. The value in the year to date spend column 234 represents the amount of true spend within a given spend category 206-218.

The annualized value of spend represented at annualized spend column 236 represents the prorated, or anticipated total spend for the year in question. As an example, in the illustrated embodiment, year to date spend column 234 represents the spend for one-third of the year (four months). Therefore, the annualized spend from column 236 is equal to approximately three times the year to date spend by column 234 (rounded to the nearest dollar).

Column 238 illustrates the previous year's spend for each respective spend category. The previous year's spend is included in order to compare this value with the annualized spend for the current year. Accordingly, column 240 is included which illustrates the anticipated present change in spending between the current year and the previous year. The percent change value is calculated according to the equation (annualized spend—previous year spend)/annualized spend).

The comparison of annualized spend to the previous year's spend allows a user to identify inconsistencies or increased/decreased spending. For example, a user may use this information to identify a spend category in which spend has significantly increased. By doing so, the user may be able to identify a particular product or service on which significantly more money is being spent. In this manner, the user may be able to approach a particular supplier and negotiate a discount based on increased spending on the product or service.

The percent change in value may also be used to identify a particular business unit or department under a specific manager's control in which spending is increasing/decreasing. Since such groups are often spread across geographic regions, trending report 200 allows a user to aggregate the information in order to analyze total true spend with regard to predefined spend categories.

In alternative embodiments, other reports may be generated which arrange true spend analysis figures according to spend per supplier and/or spend per business units. For example, a supplier report would include columns indicating a plurality of suppliers, and the corresponding year to date spend, annualized spend, previous year spend, and/or the percentage change. Similarly, the business unit report would include similar columns for each respective business unit.

FIG. 5 illustrates a communication system 500, which incorporates aspects of the present invention. A plurality of business unit servers 502-504 are coupled with a central purchasing server 506, over communication network 508. A terminal unit 510 provides an administrator with access to central purchasing server 506. Business unit servers 502-504 are used to collect and/or store accounts payable information associated with each of at least three separate business units. Such information is consolidated at central purchasing server 506. In accordance with a particular embodiment of the present invention, central purchasing server 506 is operable to receive the accounts payable information from business unit servers 502-504 and collect, manipulate, store, and/or present information to a user of terminal unit 510. In fact, central purchasing server 506 may be operable to accomplish some or all of the features and functionality described throughout this specification, for example, with regard to the method of FIG. 2. Similarly, central purchasing server 506 may be operable to generate reports such as trending report 200 of FIG. 3.

Although business unit servers 502-504 and central purchasing server 506 are coupled for communication in the illustrated embodiment, this is not always the case. Oftentimes, servers which collect and store business information regarding one or more business units or stand-alone devices, are only coupled for communication with other computer systems within the business unit. Therefore, in various embodiments, the accounts payable information may be collected manually using some form of transportable memory, hard disk, or hard copy information may be delivered to and input into central purchasing server 506.

In the illustrated embodiment, communication network 508 is a wide are network that enables communication between business unit servers 502-504 and central purchasing server 506, across multiple cities and geographic regions. However, the term “communication network” should be interpreted as generically defining any network capable of transmitting data and/or messages. Communication network 508 may comprise or be coupled with any local area network (LAN), (WAN), global distributed networks such as the Internet, Intranet, Extranet, or any other form of wireless or wireline communication network, within the teachings of the present invention.

Servers 502-504, 506 and computing device 510 may be any combination of hardware, software, and/or embedded logic that provides communication services to a user. For example, servers 502-504, 506, and terminal unit 510 may include telephones, computers running telephony software, video monitors, or any other communication hardware, software, and/or encoded logic that supports communication of media using communication network 508. In the illustrated embodiment, central purchasing server 506 includes a processor 512 and a memory module 514. Processor 512 may be a microprocessor, controller, or any other suitable computing device or resource. Memory module 514 may include any database, and may take the form of volatile or nonvolatile memory including, without limitation, magnetic media, optical media, random access memory (RAM), read-only memory (ROM), removable media, or any other suitable local or remote memory component. It should be recognized that any one or more of servers 502-504, 506 and/or terminal unit 510 may include any number or configuration of processors or memory modules, within the teachings of the present invention. Such components are operable to perform the features and functionality described herein with regard to the collection, communication, manipulation, storage, and/or analysis of data collected from a plurality of servers or terminal units.

Although embodiments of the invention and their advantages are described in detail, a person skilled in the art could make various alterations, additions, and omissions without departing from the spirit and scope of the present invention as defined by the appended claims.

What is claimed is:

1. A method for tracking spend, comprising:
receiving a plurality of accounts payable items, each accounts payable item being associated with one of a plurality of general ledger codes;
associating more than one of the plurality of general ledger codes with an associated one of a plurality of purchasing categories;
identifying at least one of the plurality of general ledger codes which does not include an associated one of the plurality of purchasing categories;
displaying unallocated spend items associated with the at least one of the general ledger codes to a user; and
receiving, from the user, information regarding a proper correlation of the spend items within the plurality of purchasing categories.

2. The method of claim 1, wherein the purchasing categories comprise suppliers associated with the spend items, and further comprising:
receiving, from the user, an identification of additional suppliers previously not identified with the accounts payable items; and
associating each of the additional suppliers with at least one of the spend items.

3. The method of claim 1, wherein the plurality of accounts payable items include a plurality of non-discretionary spend items, and a plurality of discretionary spend items, and further comprising:
associating each of the plurality of discretionary spend items with a respective one of the plurality of purchasing categories.

4. The method of claim 1, wherein the respective purchasing category comprises a supplier associated with the discretionary spend items.

5. The method of claim 1i wherein the respective purchasing category comprises a type of goods or services associated with the discretionary spend items.

6. The method of claim 1, wherein the respective purchasing category corresponds to a business unit associated with the discretionary spend items.

7. The method of claim 3, further comprising associating each of the plurality of discretionary spend items with a respective one of a plurality of types of goods or services.

8. The method of claim 7, further comprising associating each of the plurality of discretionary spend items with a respective one of a plurality of types of businesses.

9. The method of claim 1, wherein the purchasing categories comprise first purchasing categories, and further comprising associating each of the plurality of discretionary spend items with second purchasing categories.

10. The method of claim 1, wherein the purchasing categories comprise first purchasing categories, and further comprising associating each of the plurality of discretionary spend items with second and third purchasing categories.

11. The method of claim 10, wherein the first purchasing categories comprise suppliers associated with the discretionary spend items, the second purchasing categories comprise types of goods or services associated with the discretionary spend items, and the third respective spend categories comprise business units associated with the discretionary spend items.

12. The method of claim 1, further comprising:
identifying one or more general ledger codes which are likely to include one or more of a plurality of non-discretionary spend items; and
presenting each of the plurality of accounts payable items that are associated with the one or more general ledger codes to a user for analysis.

13. Logic encoded in media for tracking spend, the logic being operable to:
receive a plurality of accounts payable items, each accounts payable item being associated with one of a plurality of general ledger codes;
associate more than one of the plurality of general ledger codes with an associated one of a plurality of purchasing categories;
identify at least one of the plurality of general ledger codes which does not include an associated one of the plurality of purchasing categories;
display unallocated spend items associated with the at least one of the general ledger codes to a user; and
receive, from the user, information regarding a proper correlation of the spend items within the plurality of purchasing categories.

14. The logic encoded in media of claim 13, wherein the purchasing categories comprise suppliers associated with the spend items, and the logic being further operable to:
receive, from the user, an identification of additional suppliers previously not identified with the accounts payable items; and
associate each of the additional suppliers with at least one of the spend items.

15. The logic encoded in media of claim 13, wherein the plurality of accounts payable items include a plurality of non-discretionary spend items, and a plurality of discretionary spend items, and the logic being further operable to:
associate each of the plurality of discretionary spend items with a respective one of the plurality of purchasing categories.

16. The logic encoded in media of claim 15, wherein the logic is further operable to associate each of the plurality of discretionary spend items with a respective one of a plurality of types of goods or services.

17. The logic encoded in media of claim 13, wherein the logic is further operable to:
identify one or more general ledger codes which are likely to include one or more of a plurality of non-discretionary spend items; and
present each of the plurality of accounts payable items that are associated with the one or more general ledger codes to a user for analysis.

18. A system for tracking spend, comprising:
means for receiving a plurality of accounts payable items, each accounts payable item being associated with one of a plurality of general ledger codes;
means for associating more than one of the plurality of general ledger codes with an associated one of a plurality of purchasing categories;
means for identifying at least one of the plurality of general ledger codes which does not include an associated one of the plurality of purchasing categories;
means for displaying unallocated spend items associated with the at least one of the general ledger codes to a user; and
means for receiving, from the user, information regarding a proper correlation of the spend items within the plurality of purchasing categories.

19. The system of claim 18, wherein the purchasing categories comprise suppliers associated with the spend items, and further comprising:
means for receiving, from the user, an identification of additional suppliers previously not identified with the accounts payable items; and
means for associating each of the additional suppliers with at least one of the spend items.

20. The system of claim 19, wherein comprising:
means for identifying one or more general ledger codes which are likely to include one or more of a plurality of non-discretionary spend items; and
means for presenting each of the plurality of accounts payable items that are associated with the one or more general ledger codes to a user for analysis.
